(19) United States
(12) Patent Application Publication
(10) Pub. No.: US 2017/0158863 A1
(43) Pub. Date: Jun. 8, 2017

(54) Cooking Utensil Equipped with a Non-Stick Coating Comprising a Surface That is Mobile at High Temperatures

(71) Applicant: SEB S.A., Ecully (FR)

(72) Inventors: Laurent Caillier, Pringy (FR); Jean Waku, Chambery (FR); Jean-Luc Perillon, Saint Paul Trois Chateaux (FR)

(21) Appl. No.: 15/321,454

(22) PCT Filed: Jun. 25, 2015
(86) PCT No.: PCT/FR2015/051718

§ 371 Date: Dec. 22, 2016

(30) Foreign Application Priority Data
Jun. 25, 2014 (FR) 1455941

(51) Int. Cl. C09D 5/00; A47J 36/02; C09D 133/12; C09D 7/12; C09D 127/18

(52) U.S. Cl. CPC C09D 5/00; C09D 7/1233; C09D 127/18; C09D 7/1225; C09D 133/12; A47J 36/025

(57) ABSTRACT

Provided is a nonstick coating, including at least one outer layer including at least one infusible domain and at least one fusible domain. The infusible domain having at least one infusible material with a softening point above 200° C., and the fusible domain including at least one fusible material having a softening point above ambient temperature and at least 20° C. below the softening point of the infusible material. Also provided is a utensil including a support having two opposite faces, at least one of which is covered with a nonstick coating described above, and also to processes for manufacturing such a utensil.

The invention pertains generally to the field of coatings, and more specifically non-stick coatings for cooking utensils.

The improvement of non-stick properties is an ongoing objective in the field of cooking apparatuses.

Until very recently, this improvement was made essentially by the addition, to the coatings, of omniphobic-type materials (that is to say, both hydrophobic and lipophobic). The family of materials that are emblematic of this type of solution is typically that of fluorinated polymers in general, and more specifically perfluorinated polymers, among which polytetrafluoroethylene (PTFE) is most commonly used for this application, due to its remarkable thermal resistance and chemical inertia, among other reasons. Despite its extremely advantageous properties, PTFE nevertheless has some shortcomings in practice, notably in that which concerns the durability of its non-stick performance. Indeed, structural defects associated with the process of manufacturing PTFE films are the origin of the loss of non-stick properties, either through a break in the homogeneity of the film, or by the inclusion of charred food debris, which together cause the decline of the non-stick performance.

Solutions based on superhydrophobic and superoleophobic materials have also been developed recently. These materials are characterized by a nanostructured surface state that keeps the liquid in contact with the surface in a state of adhesion that approaches zero adhesion. A drop of liquid rests on the surface of the material and demonstrates significant mobility in response to external forces (such as inclining the surface by a few degrees, for example).

These superhydrophobic and lipophobic surfaces have proven advantageous for “simple” reference liquids such as water or organic oils, generally in cold-temperature applications.

Unfortunately it is evident that while this phenomenon remains observable at hot temperatures for these same simple liquids, this is no longer the case with more complex liquids or foods, such as milk or meat juices. In this case, the biochemical changes to the food and the interactions between the new compounds formed and the structured surface cause a sticking phenomenon between the complex bodies and the substrate.

More recently, the team of Varanasi and Aizenberg at Harvard University in the United States, introduced SLIPS technology (Slippery Liquid-Infused Porous Surfaces). This type of surface comprises a basic microstructure in which pores are filled with a liquid, generally oil, chosen to be insoluble with respect to a liquid to be repelled. The end result is a material that is known to be the most “slippery” material currently in existence. In this case, the non-stick properties are not managed by the angles of contact, but by the ability of a phase to slip over another when they cannot mix together.

The first applications of SLIPS technology came into being in the production of Ketchup® packaging that made it possible to empty every last drop of the packaging contents, and the production of very high-performance heat exchangers.

In patent document WO 2014/12080, the Aizenberg team developed an item with a slippery surface comprising a supramolecular polymer and a lubricating liquid having an affinity with the polymer, as the liquid is absorbed into the polymer, so as to form a slippery surface. In particular, this document describes a self-cleaning coating that prevents the adhesion of proteins, sugars and fats, or more generally, food. The surface of this coating is omniphobic, hydrophobic and/or lipophobic/hydrophilic. However, this document does not describe a non-stick coating that can be subjected, while remaining resistant, to repeated heating cycles at temperatures of between 140 and 250° C.

Thus, SLIPS technology, as it currently exists, could be useful in culinary applications by offering coatings with excellent non-stick properties, but in the end it is not very practical, as the required temperature conditions (continuously 140 to 250° C. during use) are far beyond those studied to date by the teams at Harvard University. Indeed, it is difficult to obtain an oil or lubricant that is both stable enough to resist repeated heating cycles and also food-safe. Moreover, the applications considered thus far do not reflect the diverse conditions encountered when cooking food. The cleaning aspects are not mentioned, and even if very little soiling occurs, for reasons of hygiene and organoleptic neutrality, it is necessary to clean a cooking utensil between each heating cycle. Yet, this cleaning could run the risk of gradually emptying the pores and therefore of weakening the non-stick properties of the material. Even if an ongoing reapplication of “lubricating oil” were required of the user, this task would be difficult to perform, both in the choice of lubricants and in the method of reapplication, which could be overwhelming for the user.

Consequently, there is a benefit to producing SLIPS-type materials with permanent effect, that are temperature resistant and that can be used in the field of cooking utensils.

Indeed, the problems of removing dirt and retaining non-stick properties are essentially observed at high temperatures; a superomniphobic surface at cold temperatures therefore offers only a relative benefit. When hot, it is necessary to deal with the soiling associated with the caramelization of foods (sugars, juices, etc.). Therefore, it is important to be able to produce this mobile phase at a high temperature (typically above 80° C.). By contrast, when cold, an omniphobic compound is sufficient; there are no known examples of PTFE becoming soiled at these temperatures.

The applicant has thus developed a non-stick coating that makes it possible to remedy the disadvantages of the prior art, in which the SLIPS technology is modified to include a mobile phase only at high temperatures (temperatures typically above 80° C.).

More particularly, the object of the present invention is a non-stick coating characterized in that it comprises at least one outer layer comprising at least one infusible area and at least one fusible area, the infusible area comprising at least one infusible material having a softening temperature higher than 200° C., and the fusible area comprising at least one fusible material having a softening temperature higher than ambient temperature and at least 20° C. lower than the softening temperature of the infusible material.

Adjusting the thermal transition of a part of the outer layer of the non-stick coating (fusible area), for example by melting a charge, a wax, a polymer, or a polymer segment, makes it possible to obtain a mobile phase (liquid film) only when it is needed, i.e., when the conditions actually begin to exert stress on the non-stick coating. This makes it possible to retain a surface that is solid when cold. The presence of this solid-when-cold area also limits the risk of losses during handling and washing, including in the dishwasher, and does not require a resurfacing operation by the user.

In the context of the present invention, the term “softening temperature” is used to refer to both the melting temperature (1^{st} order transition) of a material that is crystalline or has a crystalline phase and the glass transition temperature (2^{nd} order transition) of a material that has neither crystals nor crystalline phases.

In the context of the present invention, in the case of a compound that has no melting point, the term “melting temperature” is used to refer to the heat deflection temperature (HDT) of said compound.

In the context of the present invention, the term “very slightly soluble in water” is used to refer to a compound whose solubility in water is less than 0.01 g/L at ambient temperature.

Advantageously, the fusible material is present on at least 30% of the outer surface of the outer layer, at a coating utilization temperature between the softening temperature of the fusible material and the softening temperature of the infusible material.

Advantageously, the fusible material can be joined to the infusible material by at least one of the following: a mechanical anchoring, a covalent bond, an ionic bond and a van der Waals bond.

Advantageously, the fusible material can have a softening temperature higher than 65° C., and preferably higher than 80° C.

Advantageously, the fusible material can have a softening temperature at least 50° lower than the softening temperature of the infusible material. According to one embodiment, the infusible material can in this case have a glass transition temperature higher than 200° C. and the fusible material can have a glass transition temperature higher than ambient temperature and at least 50° C. lower than the glass transition temperature of the infusible material. According to another embodiment, the infusible material can in this case have a melting temperature higher than 200° C. and the fusible material has a glass transition temperature higher than ambient temperature and at least 50° C. lower than the melting temperature of the infusible material.

Advantageously, the outer layer can have a thickness between 200 nm and 50 μm.

According to a first advantageous embodiment, the infusible material can comprise at least one polymer or polymer segment having a softening temperature higher than 200° C.

In this embodiment, the polymer or polymer segment can advantageously be chosen from the group composed of the fluorinated polymers and copolymers, the polyamide-imides (PAI), the polyimides (PI), the phenol polymers, the polyether ether ketones (PEEK), the polyether ketone ketones (PEKK), the polyethersulfones (PES), and the polyphenylene sulfides (PPS), as well as their mixtures.

Preferably, the polymer or segment can be a fluorinated polymer or polymer segment chosen from the group composed of polytetrafluoroethylene (PTFE), perfluoroalkoxy (PFA), perfluorinated ethylene-propylene (FEP), poly(ethylene-co-tetrafluoroethylene (ETFE), polychlorotrifluoroethylene (PCTFE), and ethylene chlorotrifluoroethylene, as well as their mixtures.

In this embodiment, the polymers of mixed structure that link a chain having a high melting point with one or more chains having a melting point in the range in question (i.e. between 80° C. and 250° C.) constitute a particularly advantageous polymer class. These polymers generally have a comb-like structure (and are generally called “comb-like polymers”).

The “non-fusible” chain, i.e. the one with a melting or softening point higher than 200° C., can a be a perfluorinated or PEEK chain, and the “fusible” chain can be an alkyl (as in waxes), acrylic, methacrylic, PVDF or perfluorinated chain, as long as its melting or softening point is higher than 80° C. and lower than 200° C.

One of the advantages of this solution is that the surface material is macroscopically homogeneous, particularly when cold, and exhibits heterogeneity only when hot. Another advantage is that the mobile phase (the fusible part) remains attached to the main chain, which considerably reduces the risk of loss by evaporation or during handling or washing. A preferred material has an infusible PTFE-based main chain, and poly(HFPO)-based side chains. The average molar mass of the main chain is between 50,000 g/mol and 10⁸ g/mol and the average molar mass of the side chain or chains is between 200 and 50,000 g/mol. Side chains with a lower average molar mass do not generate sufficient mobile phase; side chains with a molar mass that is too high result in overly viscous products for which the liquid lubricant effect is insufficient.

Other examples of this type of structure include liquid crystal side chain polymers.

According to a second advantageous embodiment, the infusible material can comprise at least one metal having a softening temperature higher than 200° C.

In this embodiment, the metal can advantageously be chosen from the group composed of iron, aluminum, copper, tungsten, tin, and titanium, as well as their metallic salts and alloys.

According to an advantageous variant of this embodiment, the infusible material can comprise at least one metallic salt chosen from the group composed of aluminum nitride or carbide, copper nitride, tungsten carbide, and titanium nitride or carbide.

According to another advantageous variant of this embodiment, the infusible material can comprise at least a stainless steel and/or an aluminum alloy.

According to a third advantageous embodiment, the infusible material can comprise at least one of the following—a ceramic, an enamel, or a glass—having a softening temperature higher than 200° C.

Advantageously, the ceramic, the enamel or the glass can be free from heavy metals, and preferably from at least one of the following: iron, cadmium, and vanadium.

Advantageously, the infusible material can comprise at least one ceramic comprising at least one of the following: silica, aluminum, titanium dioxide and zirconium.

Advantageously, the infusible material can comprise at least one ceramic obtained by sol-gel process, which can preferably be obtained from at least one metal polyalkoxylate. Preferably, the metal polyalkoxylate can be a silicon-based or aluminum-based metal polyalkoxylate.

According to a fourth advantageous embodiment, the infusible material can comprise inorganic particles and/or organic particles, and/or hybrid particles, having a softening temperature higher than 200° C.

Advantageously, the infusible material can comprise inorganic particles comprising at least a metal and/or an oxide. According to a variant, the inorganic particles can comprise at least gold and/or silver. According to another variant, the inorganic particles can be chosen from the group composed of silica, aluminum, titanium dioxide, zirconium, and their mixtures.

Advantageously, for this embodiment, the infusible material can comprise organic particles comprising at least a thermoset polymer, and at least a polyurethane and/or a phenolic resin.

Advantageously, for this embodiment, the infusible material can comprise hybrid particles comprising at least a silsesquioxane, and preferably at least polyhedral oligomeric silsesquioxane (POSS).

For the first three embodiments, the fusible material, according to a first advantageous variant, can be dispersed in the infusible material.

According to a second advantageous variant, the infusible material can be dispersed in the fusible material.

According to a third advantageous variant, the infusible area can be in the form of a structured film, the structure of the infusible area having a relief comprising protuberances and cavities. In this variant, the average pitch Ar of the relief of the structure of the infusible area is advantageously less than 30 μm. Advantageously, the average peak-to-valley height Ra of the relief of the structure of the infusible area is less than 20 μm. Advantageously, the fusible material can be disposed in at least a portion of the cavities of the relief of the structure of the fusible area.

The structured film can be made from various materials such as metals, glass, ceramic, a cross-linked sol-gel material, enamels, terra cotta, or another polymer such as PEEK or PTFE.

The nanostructure of the film can be produced using various known techniques such as selective degradation of material, chemical or energetic etching, nanolithography, electroplating, self-organizing mechanisms, and phase separation. In a preferred embodiment, the structured surface must be mechanically heat resistant.

For the first three embodiments and their advantageous variants of embodiment, the fusible material can comprise at least one organic salt or ester or organometallic salt or ester having a softening temperature higher than ambient temperature and at least 20° C. lower than the softening temperature of the infusible material. Advantageously the salt or ester can be insoluble or very slightly soluble in water.

Advantageously, the salt or ester can be chosen from among the fatty acid monoacid salts or esters and the organic polyacid salts or esters. The fatty acid monoacid salt or ester can be chosen:
from the group composed of magnesium palmitate, magnesium stearate, calcium laurate, calcium stearate, and methyl stearate, or
from the group composed of methyl citrate, phenyl citrate, and diphenyl succinate.

For all of the embodiments except the one in which the fusible material comprises at least one organic salt or ester or organometallic salt or ester having a softening temperature higher than ambient temperature and at least 20° C. lower than the softening temperature of the infusible material, the fusible material can advantageously comprise at least one polymer or polymer segment having a softening temperature higher than ambient temperature and at least 20° C. lower than the softening temperature of the infusible material.

Advantageously, the polymer or polymer segment has a molar mass greater than 500 Da, and preferably between 1,000 and 50,000 Da.

Advantageously, the polymer or polymer segment can be chosen from the group composed of the alkyl chains having 12 or more carbon atoms, the fluorinated or perfluorinated waxes, the polyolefin waxes, the silicone waxes, the acrylic polymers or copolymers, the methacrylic polymers or copolymers, the polyethers or their equivalents, and the fluorinated polymers or copolymers, as well as their mixtures.

Preferably, the polymer or polymer segment can be chosen from the group constituted by the polyethylene waxes, poly(hexafluoroproplene oxide) (poly-HFPO), the tetrafluoroethylene, hexafluoropropylene and vinylidene fluoride (THV) copolymers, perfluoroalkoxy (PFA), perfluorinated ethylene-propylene (FEP), polyvinylidene fluoride (PVDF), polyvinyl fluoride (PVF), and poly(ethylene-co-tetrafluoroethylene) (ETFE), as well as their mixtures.

Advantageously, the fusible material can comprise at least one polymer segment and the infusible material comprises at least one different polymer segment, the polymer segments between them forming a block copolymer. Advantageously, the fusible material comprises at least one polyether segment and the infusible material comprises at least one polyamide segment.

Advantageously, the fusible material can comprise at least one polymer segment and is grafted to the infusible material.

Advantageously, at least one end of the polymer segment is grafted to the infusible material, and preferably at least two ends of the polymer segment are grafted to the infusible material.

Advantageously, the fusible material comprises at least one polymer segment and is grafted to inorganic particles and/or organic particles and/or hybrid particles, and the infusible material further comprises at least one polymer or polymer segment or sol-gel having a softening temperature higher than 200° C., in which the grafted particles are dispersed.

Another object of the present invention is an item characterized in that it comprises a substrate having two opposite surfaces, at least one of which is covered by a non-stick coating according to any of the preceding claims.

Advantageously, the substrate can be a material chosen from metals, glass, ceramics, and plastic materials, and preferably can be an anodized or non-anodized aluminum substrate, a polished, brushed, microblasted, sandblasted, or chemically treated aluminum substrate, a polished, brushed, microblasted, or sandblasted stainless steel substrate, a cast iron substrate, or a hammered or polished copper substrate.

Advantageously, the substrate can constitute a cookware item wherein the substrate has a concave inner surface intended to be disposed on the side facing the food that can be placed in said item, and a convex outer surface intended to be disposed facing a heat source.

Another object of the present invention is a method for producing a coating as defined above, characterized in that it comprises the following steps:
a) mixing of the fusible material with the infusible material; and
b) hot fabrication of the outer layer from the mixture of step a).

Another object of the present invention is a method for producing a coating as defined above, characterized in that it comprises the production of the outer layer according to the following steps:
a) hot fabrication of a film from the infusible material;
b) cooling of the film from step a);
c) structuring of the film from step b); and
d) hot application of the fusible material to the inside of the cavities of the structure of the film from step c).

The hot application of step d) can be performed, for example, by means of dip coating or capillary impregnation.

Another object of the present invention is a method for producing a coating as defined above, characterized in that it comprises the following steps:
a) modification of the inorganic particles and/or organic particles and/or hybrid particles having a softening temperature higher than 200° C., by grafting at least one polymer segment having a softening temperature higher than ambient temperature and at least 20° C. lower than the softening temperature of the infusible material;
b) mixing of the grafted particles and the infusible material comprising at least one polymer or polymer segment or sol-gel having a softening temperature higher than 200° C.; and
c) hot fabrication of the outer layer from the mixture of step b).

Another object of the present invention is a method for producing a coating as defined above, characterized in that it comprises the following steps:
a) modification of the polymer or polymer segment having a softening temperature higher than 200° C., by grafting at least one polymer segment having a softening temperature higher than ambient temperature and at least 20° C. lower than the softening temperature of the infusible material;
b) preparation of a suspension, a dispersion, a solution or a powder from the modified polymer or polymer segment from step a); and
c) hot fabrication of the outer layer from the product of step b).

Another object of the present invention is a method for producing a coating as defined above, characterized in that it comprises the following steps:
a) modification of a silane, by grafting at least one polymer segment having a softening temperature higher than ambient temperature and at least 20° C. lower than the softening temperature of the infusible material;
b) preparation of a sol-gel having a softening temperature higher than 200° C., from the modified silane of step a); and
c) hot fabrication of the outer layer from the product of step b).

For the three methods described above, the grafting can advantageously be a “graft from” or a “graft onto.”

Another object of the present invention is a method for producing a coating as defined above, characterized in that it comprises the following steps:
a) preparation of a block copolymer comprising the infusible material polymer segment and the fusible material polymer segment;
b) preparation of a suspension, a dispersion, a solution, or a powder from the copolymer of step a); and
c) hot fabrication of the outer layer from the product of step b).

For all of the above-mentioned methods, the outer layer can be fabricated on at least one coating sublayer.

Another object of the present invention is a method for producing a coating as defined above, characterized in that it comprises the following steps:
a) hot fabrication of a film of the infusible material on a structured coating sublayer; and
b) hot application of the fusible material to the inside of the cavities of the structure of the film.

The hot application of step b) can be performed, for example, by means of dip coating or capillary impregnation.

Another object of the present invention is a method for fabricating an item as defined above, comprising the application to at least one of the two opposite surfaces of the substrate of the coating prepared by a method as defined above.

Finally, another object of the present invention is a method for fabricating an item as previously defined, comprising the following steps:
a) hot application of a film of the infusible material to at least one of the two opposite surfaces of the substrate, wherein the surface of the substrate is structured; and
b) hot application of the fusible material to the inside of the cavities of the structure of the film.

The hot application of step b) can be performed, for example, by dip coating or capillary impregnation.

The invention is illustrated in greater detail in the following examples.

In these examples, unless otherwise indicated, all percentages and fractions are expressed in percentages by mass.

### EXAMPLES

Substrates
Substrates in the form of stainless steel plates, of the grade 316 (according to the American AISI standard) or Z6CND17-11 (according to French standard NF A 35573) type,
Substrates in the form of glass plates of the borosilicate type
Substrates in the form of Aluminum 3003 plates

Characterization Test: Measurement of the Tilt Angle (at which Unsticking Occurs)

Principle

We sought to determine what amount of tilting is necessary to enable a given liquid placed on the surface of a given substrate to begin moving. This is referred to as the tilt angle.

Procedure

The substrate for which we sought to test the surface was positioned on an inclined plane equipped with a heating mat. The substrate was brought to a temperature of 170° C.

A drop of olive oil was placed on this surface, and the tilt angle was gradually increased until the drop of oil became unstuck from the surface.

This measurement was also taken after the surface was allowed to stand at 170 CC for one hour, as well as after 30 minutes of washing in a dishwasher.

### Example 1: Laser-Structured Stainless Steel Substrate+Fluorinated SAM (Self-Assembled Monolayer)+Pure Fluorinated Wax-Based Coating

In a first step, a previously degreased stainless steel substrate is structured by laser etching. The laser used is a femtosecond laser with 5 W of power; the graph-type patterns etched were 20 μm high, 20 μm wide and are spaced 20 μm apart.

In a second step, the substrate thus laser-structured is treated in the steam phase with 1H,1H,2H,2H-perfluorooctyltriethoxysilane, in order to be silanized.

In a third step, the structured, silanized substrate is soaked by slow dip coating in a pure fluorinated wax (Dyneon THV 500GZ) brought to a liquid state at 170° C.

Results of the Tilt Angle Measurement Test

The tilt angle necessary to unstick a drop of olive oil placed on the surface brought to 170° C. is less than 2°, which shows that the adhesion force of the liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties are also maintained after 30 minutes of washing in a dishwasher, which shows that cleaning does not remove the fusible area of the coating, and that the surface therefore possesses a permanent non-stick effect.

### Example 2: Etched Glass Substrate+Fluorinated SAM (Self-Assembled Monolayer)+Coating Obtained from Fluorinated Wax in Solution

In a first step, a previously degreased borosilicate-type glass substrate is structured by optical lithography (dip coating in a resin), specific masking while exposing the resin to sunlight, patterns open), followed by oxygen plasma etching. The graph-type etched patterns are 20 μm high, 20 μm wide and spaced 20 μm apart.

In a second step, the etched glass is air plasma-activated and treated in the steam phase with 1H,1H,2H,2H-perfluorooctyltriethoxysilane, in order to be silanized.

In a third step, a fluorinated wax (Dyneon THV 500GZ), put in solution in a volatile halogenated solvent (Forane® 113 from Atofina), is deposited by dip coating on the surface of the previously etched and silanized glass substrate. This support is then baked at 200° C. to remove any solvent residue and to fill the pores of the glass with fluorinated wax.

Results of the Tilt Angle Measurement Test

The tilt angle necessary to unstick a drop of olive oil placed on the surface brought to 170° C. is less than 2°, which shows that the adhesion force of the liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties are also maintained after 30 minutes of washing in a dishwasher, which shows that cleaning does not remove the fusible area of the coating, and that the surface therefore possesses a permanent non-stick effect.

### Example 3: Aluminum Substrate+PTFE Dispersion+Post-Soaking with Fluorinated Wax in Solution

In a first step, a PTFE-type adhesive primary composition containing a PTFE resin, a PAI adhesive resin, silica and carbon black, is applied to a previously degreased aluminum plate. After this layer is dried at 70° C., a second fluorinated layer is applied, consisting of PTFE and 5% acrylic resin in emulsion. The ensemble is baked at a temperature of 430° C. for 11 minutes.

In a second step, the PTFE layer obtained is soaked by slow dip coating in a fluorinated wax (Dyneon THV 500GZ), put in solution in a volatile halogenated solvent (Forane® 113 from Atofina). Finally, the surface is baked at 200° C. to remove the solvent residues and fill the pores of the PTFE with the fluorinated wax.

Results of the tilt angle measurement test

The tilt angle necessary to unstick a drop of olive oil placed on the surface brought to 170° C. is less than 2°, which shows that the adhesion force of the liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties are also maintained after 30 minutes of washing in a dishwasher, which shows that cleaning does not remove the fusible area of the coating, and that the surface therefore possesses a permanent non-stick effect.

Variant of Example 3:

The PTFE primary layer is made porous using sacrificial particles that deteriorate during high-temperature cooking. For this variant, the characterization test is also performed. The tilt angle necessary to unstick a drop of olive oil placed on the surface brought to 170° C. is less than 2°.

### Example 4: Aluminum Substrate+Sol-Gel Coating, in which the Fluorinated Wax in Dispersion is Added as a Post-Additive

A sol-gel coating is prepared in the form of a dual-component (comprising a part A and a part B). A fluorinated wax in dispersion is added to the ensemble in post-additivation.

Part A makes it possible to add pigmentation and/or mineral loads so as to obtain a thick, cohesive film, while part B comprises the reactive silanes that will constitute the sol-gel matrix. An acid catalyst is added in part B. The silanes used are precursors with the chemical formula Rₙ-M(O—R′)₄₋ₙ, in which R and R′ are alkyl chains, and n is between 0 and 3. MTES (methyltriethoxysilane) is used in particular in this example.

Part A is prepared by gradually adding the colloidal load of silica, water, alcohol (intended to improve the compatibility of parts A and B), pigment and alumina. Then, part A is ground in a planetary grinder. Additionally, part B is prepared separately by mixing the silane with the organic acid, in order to limit the reactivity of the silane. Next, in a mixer, parts A and B are combined to create a thoroughly-mixed mixture and to enable the hydrolysis reaction. The mixing operation may be quick itself, but it is necessary to allow this mixture to react for at least 12 hours before applying it as a coating. A hydrolyzed sol-gel solution is obtained, to which a surfactant of the fluorinated polyether type (Polyfox 151N) is added in a proportion of 1% by weight with respect to the wet sol-gel solution (prior to adding the fluorinated wax).

The overall formulation of the hydrolyzed sol-gel composition thus obtained (prior to adding the fluorinated wax) is indicated in Table 1 below:

TABLE 1

| | | Percentage by |
|---|---|---|
| Components | Part | mass |
| Colloidal silica (30% dry matter) | A | 27.5 |
| Distilled water | A | 7.0 |
| Isopropanol | A | 3.0 |
| Black pigment FA 1220 | A | 14.0 |
| Alumina (d50 = 5 μm) | A | 12.0 |
| MTES (methyltriethoxysilane) | B | 36.1 |
| Formic acid | B | 0.4 |
| TOTAL | | 100.0 |

The next step is the addition, while stirring, of the fluorinated wax in dispersion (Dyneon THV 340Z—fusion point 145° C.) at a content of 1% by mass with respect to the total wet sol-gel formulation. After mixing, the ensemble (hydrolyzed sol-gel solution+fluorinated wax) is then applied by spray to a previously degreased aluminum substrate. Baking for 30 minutes at 200° C. finalizes the cross-linking of the sol-gel inorganic network.

Results of the Tilt Angle Measurement Test

The tilt angle necessary to unstick a drop of olive oil placed on the surface brought to 170° C. is less than 2°, which shows that the adhesion force of the liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties were also maintained after 30 minutes of washing in a dishwasher, which shows that cleaning does not remove the fusible area of the coating, and that the surface therefore possesses a permanent non-stick effect.

Variant 1 of Example 4:

The sol-gel layer used is made porous using sacrificial particles that deteriorate during high-temperature cooking.

For this variant, the characterization test is also performed. The tilt angle necessary to unstick a drop of olive oil placed on the surface brought to 170° C. is less than 2°.

Variant 2 of Example 4:

The sol-gel layer used is made mesoporous using micelle particles which create gaps after high-temperature cooking.

For this variant, the characterization test is also performed. The tilt angle necessary to unstick a drop of olive oil placed on the surface brought to 170° C. is less than 2°.

### Example 5: Aluminum Substrate+Sol-Gel Coating with Calcium Stearate

A sol-gel composition is prepared in the same way as in Example 4, in the form of a dual-component (with a part A and a part B). Part A of this dual-component is prepared by gradually adding the colloidal silica load, water, alcohol (intended to improve the compatibility of parts A and B), pigment, alumina and calcium stearate powder. Then, part A is ground in a planetary grinder. In addition, part B is prepared separately by mixing the silane with the organic acid in order to limit the reactivity of the silane. Next, in a

mixer, parts A and B are combined to create a thoroughly-mixed mixture and to enable the hydrolysis reaction. The mixing operation may be quick itself, but it is necessary to allow this mixture to react for at least 12 hours prior to applying it as a coating.

The overall formulation of the hydrolyzed sol-gel composition thus obtained is indicated in Table 2 below:

TABLE 2

| | | Percentage by |
|---|---|---|
| Components | Part | mass |
| Colloidal silica (30% dry matter) | A | 27.5 |
| Distilled water | A | 7.0 |
| Isopropanol | A | 3.0 |
| Black pigment FA 1220 | A | 14.0 |
| Alumina (d50 = 5 μm) | A | 11.0 |
| Calcium stearate | A | 1.0 |
| MTES (methyltriethoxysilane) | B | 36.1 |
| Formic acid | B | 0.4 |
| TOTAL | | 100.0 |

After mixing, the ensemble is applied by spray to a previously degreased aluminum substrate. Baking for 60 minutes at 150° C. finalizes the cross-linking of the sol-gel inorganic network.

Results of the Tilt Angle Measurement Test

The tilt angle necessary to unstick a drop of olive oil placed on the surface brought to 170° C. is less than 2°, which shows that the adhesion force of the liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties are also maintained after 30 minutes of washing in a dishwasher, which shows that cleaning does not remove the fusible area of the coating, and that the surface therefore possesses a permanent non-stick effect.

### Example 6: Aluminum Substrate+Sol-Gel Coating, in which the Polyethylene Wax has been Added in Post-Additivation

A sol-gel composition is prepared in the same way as in Examples 4 and 5, in the form of a dual-component (with a part A and a part B). Part A of this dual-component is prepared by successively adding the colloidal silica load, water, alcohol (intended to improve the compatibility of parts A and B), pigment and alumina. Then, part A is ground in a planetary grinder. In addition, part B is prepared separately by mixing the silane with the organic acid in order to limit the reactivity of the silane. Next, in a mixer, parts A and B are combined to create a thoroughly-mixed mixture and to enable the hydrolysis reaction. The mixing operation may be quick itself, but it is necessary to allow this mixture to react for at least 12 hours prior to applying it as a coating.

The overall formulation of the hydrolyzed sol-gel composition thus obtained (before adding the polyethylene wax) is indicated in Table 3 below:

TABLE 3

| | | Percentage by |
|---|---|---|
| Components | Part | mass |
| Colloidal silica (30% dry matter) | A | 27.5 |
| Distilled water | A | 7.0 |
| Isopropanol | A | 3.0 |
| Black pigment FA 1220 | A | 14.0 |
| Alumina (d50 = 5 μm) | A | 12.0 |
| MTES (methyltriethoxysilane) | B | 36.1 |
| Formic acid | B | 0.4 |
| TOTAL | | 100.0 |

Next is the addition, while stirring, of the polyethylene wax CRAYVALLAC® WW-1001 (in dispersion) in a proportion of 1% by mass with respect to the total wet sol-gel formulation.

After mixing, the ensemble is applied by spray to a previously degreased aluminum substrate. Baking for 60 minutes at 150° C. finalizes the cross-linking of the sol-gel inorganic network.

Results of the Tilt Angle Measurement Test

The tilt angle necessary to unstick a drop of olive oil placed on the surface brought to 170° C. is less than 2°, which shows that the adhesion force of the liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties are also maintained after 30 minutes of washing in a dishwasher, which shows that cleaning does not remove the fusible area of the coating, and that the surface therefore possesses a permanent non-stick effect.

### Example 7: Aluminum Substrate+PTFE Dispersion, to which Silica Particles Grafted with Fluorinated Branches are Added

Grafting Fluorinated Branches onto Silica Particles:

A poly-HFPO silanized oligomer with the following formulation is prepared separately:

F(CF(CF₃)CF₂O)ₙCF(CF₃)CONHC₃H₆Si(OC₂H₅)₃

in which the fluorinated chain has a softening point of greater than 80° C. (Mn>6000 Da). The oligomer is solubilized in a fluorinated solvent (Fluorinert FC770 (10% solution)), and then put in contact with the silica (Aerosil 100).

The ensemble is maintained at 85° C. while being stirred to facilitate the grafting of the fluorinated branches onto the silica. After the reaction, the reaction medium is filtered, and the residue is rinsed with the reaction solvent and then dried in a vacuum.

The particles obtained are silica particles grafted with HFPO. These particles are analyzed by differential scanning calorimetry (DSC): a first-order transition is observed around 85° C.

Inclusion in a PTFE Resin-Based Formulation:

These silica particles grafted with HFPO are added to a PTFE dispersion-based formulation, the composition of which is shown in Table 4 below:

TABLE 4

| Components | Percentage by mass |
|---|---|
| PTFE dispersion (60% dry matter) | 72.2 |
| HFPO grafted silica | 2.2 |
| Fluorinated surfactant | 0.4 |
| Demineralized water | 21.6 |
| Monopropylene glycol | 3.6 |
| TOTAL | 100.0 |

This composition is applied to a previously prepared aluminum substrate. After baking (at 380° C.) to ensure that a film forms on the ensemble, a dry film is obtained with a thickness of 5 μm.

Results of the Tilt Angle Measurement Test

The tilt angle necessary to unstick a drop of olive oil placed on the surface brought to 170° C. is less than 2°, which shows that the adhesion force of the liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties are also maintained after 30 minutes of washing in a dishwasher, which shows that cleaning does not remove the fusible area of the coating, and that the surface therefore possesses a permanent non-stick effect.

### Example 8: Stainless Steel Substrate+Sol-Gel Coating, in which Silica Particles Grafted with Fluorinated Branches are Added

Grafting of Fluorinated Branches onto Silica Particles:

In the same manner as in Example 7, HFPO-grafted silica particles are prepared.

Inclusion in a Sol-Gel Based Formulation:

These grafted silica particles are added to a sol-gel-based formulation, the composition of which is shown in Table 5 below:

TABLE 5

| | | Percentage by |
|---|---|---|
| Components | Part | mass |
| Fluorinated grafted silica | A | 3.6 |
| Distilled water | A | 20.4 |
| Isopropanol | A | 6.0 |
| Butyl glycol | A | 3.6 |
| Colloidal silica (30% dry matter) | A | 23.9 |
| Fluorinated surfactant | A | 1.2 |
| TEOS (tetraethoxysilane) | B | 19.1 |
| MTES (methyltriethoxysilane) | B | 20.9 |
| Formic acid | B | 1.3 |
| TOTAL | | 100.0 |

This composition is prepared in the form of a dual-component (with a part A and a part B). The compounds of parts A and B are mixed separately and then they are combined in a mixer that is stirred vigorously to obtain a thoroughly-mixed mixture and to enable the hydrolysis reaction. It is allowed to rest for 12 hours, and then the mixture is applied to a previously prepared stainless steel substrate. After baking at 260° C. for 30 minutes to ensure that a film forms on the ensemble, a dry film is obtained with a thickness of 5 μm.

Results of the Tilt Angle Measurement Test

The tilt angle necessary to unstick a drop of olive oil placed on the surface brought to 170° C. is less than 2°, which shows that the adhesion force of the liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties are also maintained after 30 minutes of washing in a dishwasher, which shows that cleaning does not remove the fusible area of the coating, and that the surface therefore possesses a permanent non-stick effect.

### Example 9: Stainless Steel Substrate+Sol-Gel Coating, to which POSS Particles Grafted with Fluorinated Branches are Added

Grafting of Fluorinated Branches to a Poly-Silsesquioxane (POSS)

A fluorinated POSS is prepared by causing a fluorinated vinyl derivative to react, by simple addition, with a polyhydride silsesquioxane (use of a palladium-derived catalyst) entirely substituted so as to attach a fluorinated chain to each of the SiH groups, according to the formula developed as indicated below:

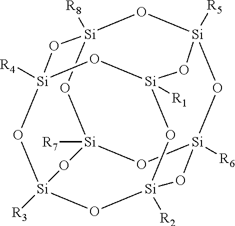

In which R_{1,2,3,4,5,6,7,8}═F(CF(CF₃)CF₂O)ₙCF CF₃)CH₂CH₂— in which the Mn molecular mass is greater than 6000 Da and the softening point is greater than 85° C.

Inclusion in a Sol-Gel-Based Formulation:

The fluorinated POSS obtained is added to a sol-gel formulation, the composition of which is indicated in Table 6 below:

TABLE 6

| | | Percentage by |
|---|---|---|
| Components | Part | mass |
| Fluorinated POSS | A | 4.0 |
| Distilled water | A | 20.0 |
| Isopropanol | A | 6.0 |
| Butyl glycol | A | 3.6 |
| Colloidal silica (30% dry matter) | A | 23.9 |
| Fluorinated surfactant | A | 1.5 |
| TEOS (tetraethoxysilane) | B | 19.1 |
| MTES (methyltriethoxysilane) | B | 20.6 |
| Formic acid | B | 1.3 |
| TOTAL | | 100.0 |

This composition is prepared in the form of a dual-component (with a part A and a part B). The compounds of parts A and B are mixed separately and then they are combined in a mixer that is stirred vigorously to obtain a thoroughly-mixed mixture and to enable the hydrolysis reaction. It is allowed to rest for 12 hours, and then the mixture is applied to a previously prepared stainless steel substrate. After baking at 260° C. for 30 minutes to ensure that a film forms on the ensemble, a dry film is obtained with a thickness of 5 μm.

Results of the Tilt Angle Measurement Test

The tilt angle necessary to unstick a drop of olive oil placed on the surface brought to 170° C. is less than 2°, which shows that the adhesion force of the liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties are also maintained after 30 minutes of washing in a dishwasher, which shows that cleaning does not remove the fusible area of the coating, and that the surface therefore possesses a permanent non-stick effect.

### Example 10: Aluminum Substrate+Coating of a Comb-Structured Polymer with a CF2 Main Chain

A fluorinated copolymer is prepared by causing the following three monomers to react under the usual conditions in the proportions by mass indicated below:
TFE tetrafluoroethylene (C₂F₄): 90%
HFP Hexafluoropropene (C₃F₆): 5%
HFPO oligomer C₄F₃O(CF(CF₃)CF₂O)ₙCF═C F₂ (Mn>6000 Da): 5%

A polymer is obtained in the form of a latex dispersion in water, at a concentration of 55% by weight. The polymer has a comb-like structure with a softening of the main chain at 285° C. and a softening of the pendant chains at 85° C.

The latex dispersion is applied by spray to a previously degreased aluminum substrate. Then, the coated substrate is baked at 370° C. for 10 minutes. A finishing coating is obtained in the form of a dry film with a thickness of 5 μm.

Results of the Tilt Angle Measurement Test

The tilt angle necessary to unstick a drop of olive oil placed on the surface brought to 170° C. is less than 2°, which shows that the adhesion force of the

liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties are also maintained after 30 minutes of washing in a dishwasher, which shows that cleaning does not remove the fusible area of the coating, and that the surface therefore possesses a permanent non-stick effect.

### Example 11: Aluminum Substrate+Coating of a Comb-Structured Polymer with a Fluorinated Lateral Chain

A functional methacrylic copolymer is prepared by copolymerizing the following two monomers in a solvent medium in the proportions by mass indicated below:
methyl methacrylate: 95%
methacrylic acid: 5%

Grafted onto the polymer, in a stoichiometric quantity with respect to the available acid functions, is a hydroxylated fluorinated oligomer of F(CF(CF₃)CF₂O)ₙCF(CF₃)CH₂CH₂—OH, the molecular mass of which is greater than 4500 Da.

The polymer obtained has a comb-like structure, with a main chain having a softening temperature of 140° C. and pendant chains with a softening temperature of 85° C.

The polymer obtained is placed in solution in a solvent phase, and then applied to a previously degreased aluminum substrate. Then, the coated substrate is baked at 200° C. for 1 hour and a dry film is obtained with a thickness of 5 μm.

Results of the Tilt Angle Measurement Test

The tilt angle necessary to unstick a drop of olive oil placed on the surface brought to 170° C. is less than 2°, which shows that the adhesion force of the liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties are also maintained after 30 minutes of washing in a dishwasher, which shows that cleaning does not remove the fusible area of the coating, and that the surface therefore possesses a permanent non-stick effect.

### Example 12: Aluminum Substrate+Coating Made of a Comb-Structured Polymer with a Siliconated Fluorinated Lateral Chain

A functional methacrylic copolymer is prepared by copolymerizing the following two monomers in a solvent medium in the proportions by mass indicated below:
methyl methacrylate: 95%
methacrylic acid: 5%

Grafted onto the polymer, in a stoichiometric quantity with respect to the available acid functions, is a monohydroxylated silicone oligomer (R)₃SiO—(Si(CH₃)₂)ₙ—Si(CH₃)₂OH, the molecular mass of which is greater than 1000 Da and in which R is a non-polar alkyl group.

The polymer obtained has a comb-like structure with a softening of the main chain at 140° C. and a softening of the pendant chains at 85° C.

The polymer obtained is put in solution in a solvent phase, and then applied to a previously degreased aluminum substrate. Then, the coated substrate is baked at 200° C. for 15 minutes and a dry film is obtained with a thickness of 5 μm.

Results of the Tilt Angle Measurement Test

The tilt angle necessary to unstick a drop of olive oil placed on the surface brought to 170° C. is less than 2°, which shows that the adhesion force of the liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties are also maintained after 30 minutes of washing in a dishwasher, which shows that cleaning does not remove the fusible area of the coating, and that the surface therefore possesses a permanent non-stick effect.

### Example 13: Aluminum Substrate+Liquid Crystal Polymer Coating

A functional methacrylic copolymer is prepared by copolymerizing the following two monomers in a solvent medium in the proportions by mass indicated below:
methyl methacrylate: 30%
6-cyanobiphenyloxy-1-hexyl methacrylate: 70%

A liquid crystal polymer is obtained, which is placed in solution in a solvent phase, and then applied to a previously degreased aluminum substrate. Then, the coated substrate is baked at 200° C. for 15 minutes and a dry film is obtained with a thickness of 5 μm.

Results of the Tilt Angle Measurement Test

The tilt angle necessary to unstick a drop of olive oil placed on the surface brought to 170° C. is less than 2°, which shows that the adhesion force of the liquid on the mobile surface when hot is particularly weak: the surface possesses good non-stick properties at high temperatures.

These properties are maintained after the surface is allowed to stand at 170° C. for one hour, which shows that this surface is resistant to high temperatures and is therefore compatible with use as a cooking utensil.

These properties are also maintained after 30 minutes of washing in a dishwasher, which shows that cleaning does not remove the fusible area of the coating, and that the surface therefore possesses a permanent non-stick effect.

1. A non-stick coating characterized in that it comprises at least one outer layer comprising at least one infusible area and at least one fusible area, the infusible area comprising at least one infusible material having a softening temperature higher than 200° C., and the fusible area comprising at least one fusible material having a softening temperature higher than ambient temperature and at least 20° C. lower than the softening temperature of the infusible material.

2. A coating according to claim 1, wherein the fusible material is present on at least 30% of the outer surface of the outer layer, at a coating utilization temperature between the softening temperature of the fusible material and the softening temperature of the infusible material.

3. A coating according to claim 1, wherein the fusible material is joined to the infusible material by at least one of the following: a mechanical anchoring, a covalent bond, an ionic bond and a van der Waals bond.

4. A coating according to claim 1, wherein the fusible material has a softening temperature higher than 65° C.

5. A coating according to claim 1, wherein the fusible material has a softening temperature at least 50° lower than the softening temperature of the infusible material.

6. A coating according to claim 5, wherein the infusible material has a glass transition temperature higher than 200° C. and the fusible material has a glass transition temperature higher than ambient temperature and at least 50° C. lower than the glass transition temperature of the infusible material.

7. A coating according to claim 5, wherein the infusible material has a melting temperature higher than 200° C. and the fusible material has a glass transition temperature higher than ambient temperature and at least 50° C. lower than the melting temperature of the infusible material.

8. A coating according to claim 1, wherein the outer layer has a thickness between 200 nm and 50 μm.

9. A coating according to claim 1, wherein the infusible material comprises at least one polymer or polymer segment having a softening temperature higher than 200 C.

10. A coating according to claim 9, wherein the polymer or polymer segment is chosen from the group composed of fluorinated polymers and copolymers, polyamide-imides (PAI), polyimides (PI), phenol polymers, polyether ether ketones (PEEK), polyether ketone ketones (PEKK), polyethersulfones (PES), and polyphenylene sulfides (PPS), as well as their mixtures.

11. A coating according to claim 1, wherein the infusible material comprises at least one metal having a softening temperature higher than 200° C.

12. A coating according to claim 11, wherein the metal is chosen from the group composed of iron, aluminum, copper, tungsten, tin, and titanium, as well as their metallic salts and alloys.

13. A coating according to claim 1, wherein the infusible material comprises at least one: —a ceramic, an enamel, or a glass—, having a softening temperature higher than 200° C.

14. A coating according to claim 13, wherein the ceramic, the enamel or the glass is free from heavy metals.

15. A coating according to claim 13, wherein the infusible material comprises at least one ceramic comprising at least one of: silica, aluminum, titanium dioxide and zirconium.

16. A coating according to claim 13, wherein the infusible material comprises at least one ceramic obtained by a sol-gel process.

17. A coating according to claim 1, wherein the infusible material comprises inorganic particles and/or organic particles, and/or hybrid particles, having a softening temperature higher than 200° C.

18. A coating according to claim 17, wherein the infusible material comprises inorganic particles comprising at least a metal and/or an oxide.

19. A coating according to claim 17, wherein the infusible material comprises organic particles comprising at least a thermoset polymer.

20. A coating according to claim 17, wherein the infusible material comprises hybrid particles comprising at least a silsesquioxane.

21. A coating according to claim 1, wherein the fusible material is dispersed in the infusible material.

22. A coating according to claim 1, wherein the infusible material is dispersed in the fusible material.

23. A coating according to claim 1, wherein the infusible area is in a form of a structured film, the structure of the infusible area having a relief comprising protuberances and cavities.

24. A coating according to claim 23, wherein the average pitch Ar of the relief of the structure of the infusible area is less than 30 μm.

25. A coating according to claim 24, wherein the average peak-to-valley height Ra of the relief of the structure of the infusible area is less than 20 μm.

26. A coating according to claim 23, wherein the fusible material is disposed in at least part of the cavities of the relief of the structure of the infusible area.

27. A coating according to claim 1, wherein the fusible material comprises at least one organic salt or ester or organometallic salt or ester having a softening temperature higher than ambient temperature and at least 20° C. lower than the softening temperature of the infusible material.

28. A coating according to claim 27, wherein the salt or ester is insoluble or very slightly soluble in water.

29. A coating according to claim 27, wherein the salt or ester is chosen from among fatty acid monoacid salts or esters and organic polyacid salts or esters.

30. A coating according to claim 1, wherein the fusible material comprises at least one polymer or polymer segment having a softening temperature higher than ambient temperature and at least 20° C. lower than the softening temperature of the infusible material.

31. A coating according to claim 30, wherein the polymer or polymer segment has a molar mass greater than 500 Da.

32. A coating according to claim 30, wherein the polymer or polymer segment is chosen from the group composed of alkyl chains having 12 or more carbon atoms, fluorinated or perfluorinated waxes, polyolefin waxes, silicone waxes, acrylic polymers or copolymers, methacrylic polymers or copolymers, polyethers or their equivalents, and fluorinated polymers or copolymers, as well as their mixtures.

33. A coating according to claim 30, wherein the fusible material comprises at least one polymer segment and the infusible material comprises at least one different polymer segment, and wherein polymer segments between them forming a block copolymer.

34. A coating according to claim 33, wherein the fusible material comprises at least one polyether segment and the infusible material comprises at least one polyamide segment.

35. A coating according to claim 30, wherein the fusible material comprises at least one polymer segment and is grafted to the infusible material.

36. A coating according to claim 35, wherein at least one end of the polymer segment is grafted to the infusible material.

37. A coating according to claim 35, wherein the fusible material comprises at least one polymer segment and is grafted to inorganic particles and/or organic particles and/or hybrid particles, and wherein the infusible material further comprises at least one polymer or polymer segment or sol-gel having a softening temperature higher than 200° C., in which the grafted particles are dispersed.

38. An item characterized in that it comprises a substrate having two opposite surfaces, at least one of which is covered by a non-stick coating according to claim 1.

39. A method for producing a coating as defined according to claim 1, characterized in that it comprises the following steps:
a) mixing of the fusible material with the infusible material; and
b) hot fabrication of the outer layer from the mixture of step a).

40. A method for producing a coating as defined according to claim 1, characterized in that it comprises the production of the outer layer according to the following steps:
a) hot fabrication of a film from the infusible material;
b) cooling of the film from step a);
c) structuring of the film from step b); and
d) hot application of the fusible material to the inside of the cavities of the structure of the film from step c).

41. The method for producing a coating as defined according to claim 37, characterized in that it comprises the following steps:
a) modification of the inorganic particles and/or organic particles and/or hybrid particles having a softening temperature higher than 200° C., by grafting at least one polymer segment having a softening temperature higher than ambient temperature and at least 20° C. lower than the softening temperature of the infusible material;
b) mixing of the grafted particles and the infusible material comprising at least one polymer or polymer segment or sol-gel having a softening temperature higher than 200° C.; and
c) hot fabrication of the outer layer from the mixture of step b).

42. The method for producing a coating as defined according to claim 35, characterized in that it comprises the following steps:
a) modification of the polymer or polymer segment having a softening temperature higher than 200° C., by grafting at least one polymer segment having a softening temperature higher than ambient temperature and at least 20° C. lower than the softening temperature of the infusible material;
b) preparation of a suspension, a dispersion, a solution or a powder from the modified polymer or polymer segment from step a); and
c) hot fabrication of the outer layer from the product of step b).

43. The method for producing a coating as defined according to claim 35, characterized in that it comprises the following steps:
a) modification of a silane, by grafting at least one polymer segment having a softening temperature higher than ambient temperature and at least 20° C. lower than the softening temperature of the infusible material;
b) preparation of a sol-gel having a softening temperature higher than 200° C., from the modified silane of step a); and
c) hot fabrication of the outer layer from the product of step b).

44. The method according to claim 41, wherein the grafting is a “graft from” or a “graft onto.”

45. The method for producing a coating as defined according to claim 33, characterized in that it comprises the following steps:
a) preparation of a block copolymer comprising the infusible material polymer segment and the fusible material polymer segment;
b) preparation of a suspension, a dispersion, a solution, or a powder from the copolymer of step a); and
c) hot fabrication of the outer layer from the product of step b).

46. The method according to claim 39, wherein the outer layer is fabricated on at least one coating sublayer.

47. The method for producing a coating as defined according to claim 1, characterized in that it comprises the following steps:
a) hot fabrication of a film of the infusible material on a structured coating sublayer; and
b) hot application of the fusible material to the inside of the cavities of the structure of the film.

48. A method for fabricating an item, comprising the application of a non-stick coating to at least one of two opposite surfaces of a substrate, wherein the coating is prepared by the method according to claim 39.

49. The method for fabricating an item according to claim 38, comprising the following steps:
a) hot application of a film of the infusible material to at least one of the two opposite surfaces of the substrate, wherein the surface of the substrate is structured; and
b) hot application of the fusible material to the inside of the cavities of the structure of the film.
